(19) United States
(12) Patent Application Publication
(10) Pub. No.: US 2002/0059246 A1
(43) Pub. Date: May 16, 2002

(54) Method of distributing information to emergency personnel

(76) Inventor: Steve Rowe, Las Vegas, NV (US)

Correspondence Address: Robert Ryan Morishita, Anderson & Morishita, L.L.C., Suite 127, 3311 S. Rainbow, Las Vegas, NV, 89146, US

(21) Appl. No.: 09/758,412

(22) Filed: Jan. 10, 2001

Related U.S. Application Data
(63) Continuation-in-part of application No. 09/610,174, filed on Jul. 5, 2000.
(60) Provisional application No. 60/143,779, filed on Jul. 13, 1999.

(51) Int. Cl. G06F 7/00

(52) U.S. Cl. 707/10

(57) ABSTRACT

A method for collecting emergency information from users. The user transmits data including at least a name and identifying indicia to a central storage server which stores the emergency information and indexes the information by name. Alternatively, the information is stored on substation computers located at police stations, fire stations, hospitals, and other places where the emergency information may be useful. In an emergency, the emergency personnel retrieve the information using the substation computers for use during the emergency.

### PRIOR APPLICATION DATA

The present application is a continuation-in-part of application Ser. No. 09/610,174 entitled “Method of Distributing Information to Emergency Personnel” filed Jul. 5, 2000 by Applicant herein which, in turn, claims priority to provisional application serial No. 60/143,779 entitled “Method of Distributing Information to Emergency Personnel” filed Jul. 13, 1999 by Applicant herein.

### FIELD OF THE INVENTION

The present invention relates to information storage and distribution. Specifically, the present invention is a method for collecting information from users and distributing the information to emergency personnel to assist the emergency personnel in emergency situations.

### BACKGROUND OF THE INVENTION

To best handle emergency situations in a fast, efficient, and thorough manner, emergency personnel need information. For example, in a fire emergency, firefighters typically know the address of the building afire and whether the building is a residential building or a commercial building. However, often firefighters do not know how many persons are inside the burning building, where the persons may be located, where the utility shutoff valves are located, where flammable materials are located, and other information which would speed the firefighter's job as well as improve the firefighters' chances for preventing injuries and fatalities to occupants of the building.

In other kinds of natural disasters, knowing the number of occupants and the inhabited areas of a building could aid rescue efforts. For example, if a building collapsed due to an earthquake, tornado, hurricane, flood, or the like, rescuers could concentrate their search efforts on the inhabited areas of the building.

In these types of disaster situations, emergency personnel often have to gather information, such as blueprints, utility layouts, building tenant lists, and personal observations from neighbors, relatives, and other occupants of the building, to attempt to piece together the number persons in the building and the likely location of those persons. However, there are many drawbacks to gathering this essential information in this fashion. First, gathering information from a variety of sources can take a long time—sometimes too long for an emergency situation.

Second, gathering information in this manner does not tell emergency personnel exactly what they need to know. That is, tenant lists, blueprints, and personal observations of others do not tell emergency personnel which areas of the building are occupied and the number of occupants. Thus, emergency personnel must infer from the information gathered the number of occupants and their probable location in the building. The drawback, however, is that the emergency personnel risk making incorrect assumptions and miscalculations in the process.

Third, gathering information in this manner relies on other persons, companies, and agencies which may have also suffered damage in the disaster. In other words, if the only tenant list is in the burning building, the emergency personnel will not be able to use the tenant list. Similarly, if the entire neighborhood has been hit by a tornado, it will be difficult to piece information together from neighbors regarding the number of people living in any particular house.

Aside from its use in disaster situations, police would also be aided by knowing the number and location of occupants in a building if the building needed to be evacuated. Police would also be aided by information such as the location, description, and serial numbers of valuables in the event of a theft.

Information such as that described above, would also be useful to insurance companies for two reasons. First, information about the valuables contained in the building could be used by insurance companies to verify claims in the event of a disaster. Second, and more importantly, knowing that such information is available to emergency personnel, insurance companies could recalculate the insurance rates based on the improved probability that loss of life and property could be minimized.

A related problem is that, in a medical emergency, emergency medical technicians (“EMTs”) are often dispatched without knowledge of the patient's medical history or current medical condition. To quickly arrive at a correct diagnosis and apply the appropriate treatment, it is often essential that the EMTs know whether the patient suffers from any chronic illnesses, whether the patient has any allergies, and other relevant information in the patient's medical history. To compound the problem, often the patient himself or herself is incapacitated and cannot communicate information about the patient's medical history to the EMTs.

Thus, there is a need in the art for a method for collecting information about the number and location of occupants in a building, the medical condition of the occupants, the location of valuables in a building, the layout of the building, and other relevant information and distributing that information to emergency personnel in the event of emergency.

### SUMMARY OF THE INVENTION

The emergency information which would be helpful to emergency personnel is compiled by the user. This emergency information includes the name and identifying indicia of the person. The identifying indicia for each person may optionally include a photograph, description, fingerprint, or other identifying indicia. The emergency information may also optionally include information on the person's health status.

In one optional embodiment, the user inputs the emergency information described above into a software program. In such an embodiment, the software program allows a user to input a scan of a photograph, fingerprint, or the like and input emergency information in the form of text. The software may be distributed through retail sales, may be available through the Internet, or may be distributed with other software. Additionally, the software may be distributed by insurance companies, home owner associations, or the like.

In an alternate embodiment, the user transmits the collected emergency information, including the scans of photographs, fingerprints, or the like and the text information, to a central storage server operated by an operator. The operator then formats and inputs the information into a database.

To transmit the emergency information to a central storage server, the software optionally transmits the gathered information through the Internet or a direct modem connection to the central storage server. In an alternate embodiment, the software generates a file which may be transmitted as an electronic mail (“e-mail”) attachment to the central storage server.

In one embodiment of the present invention, the central storage server, stores the information in a database and indexes the information by the name or street address of the person identified. In an alternate embodiment, the central computer determines, based on the street address of the person, the nearest substation used to retrieve the emergency information, and transmits the information to that substation to be stored locally. The data could be updated manually or automatically.

In the event of an emergency, a dispatcher would alert the appropriate emergency personnel of the name or street address of the person involved in the emergency. The emergency personnel would obtain the emergency information stored either by using a substation computer to access the information themselves, either by accessing the information stored locally or by accessing the database at the central storage server, or by receiving the information from a dispatcher who has accessed the information stored locally or accessed the database at the central storage server.

It is an object of the present invention is to provide a method for emergency personnel to receive accurate information about the name and identifying indicia of a person in a fast, efficient manner from a single source.

### BRIEF DESCRIPTION OF THE DRAWINGS

FIG. 1 shows a block diagram of the input steps according to one embodiment of the present invention;

FIG. 2 shows a block diagram of the retrieval steps according to the embodiment of FIG. 1;

FIG. 3 shows a block diagram of the input steps according to an alternate embodiment of the present invention;

FIG. 4 shows a block diagram of the retrieval steps according to the embodiment of FIG. 3;

FIG. 5 shows a schematic of the a central storage server and substation computer network according to an embodiment of the present invention.

### DESCRIPTION

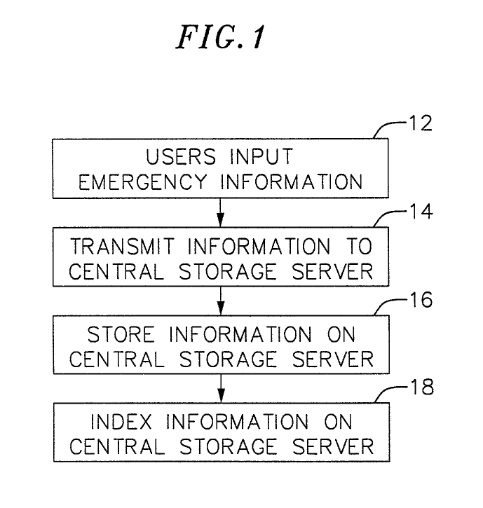

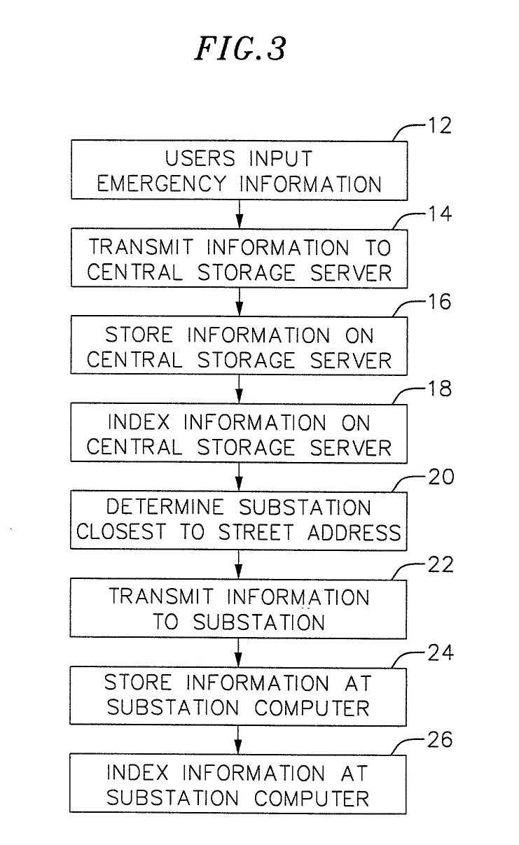

As shown in FIGS. 1 and 3, the method begins with a user inputting 12 emergency information to be transmitted 14 to the central storage server 56. Such information includes, as will be described in more detail below, the name of a person and information or indicia identifying the person. Optionally, the person's street address in included as well.

The present method begins with the user transmitting 14 information to a central storage server 56. The step of collecting and transmitting 14 the information could take many forms. For example, in a first embodiment of the present method, the user fills out a form provided over a computer network such as the Internet. The fields of the form are then transmitted 14 to a central storage server 56. As described above, the data include at least the name of a person and identifying indicia such as a photograph, fingerprints, a physical description, or the like.

In such an embodiment, the user has various options for inputting the identifying indicia for transmission 14. For example, a user could scan the identifying indicia with a scanner to thereby create a file that may be transmitted 14 to the central storage server 56. Alternatively, the user may physically mail a copy of the identifying indicia and the associated data to the operator of the central storage server 56. The operator may then enter 12 the data and identifying indicia into the central storage server 56.

In an optional embodiment, the user also inputs 12 data such as text describing the person. Specifically, a description may be provided that describes any identifying characteristics of the person.

In an optional alternate embodiment of the method of the present invention, software is utilized to obtain the appropriate information from users and transmit 14 the information to the central storage server 56. A variety of different distribution means may be utilized to distribute the software. For example, the software may be sold through retail outlets or mail order outlets, made available for download from a computer network such as the Internet, distributed along with other software, or the like. The software may also be distributed by home owner associations, homebuilders or homebuilder organizations, insurance companies, police or fire authorities, or the like.

The software itself allows a user to input 12 emergency information, i.e. name and identifying indicia, to be transmitted and stored on a central storage server 56.

Once the user has obtained 10 a copy of the software, the user collects the information described above. The user first inputs 12 the name of the person. The user then inputs 12 the identifying indicia into the software. In one embodiment, the user uses a form to input 12 the necessary information. In an alternate embodiment, the user scans a printed form of the identifying indicia, such as a photograph, fingerprints, or the like, with a scanner which inputs 12 the identifying indicia into the software. In yet another embodiment, the user is provided with a scanned form of the identifying indicia stored on a computer readable medium, such as a magnetic disc, a laser readable disc, or other medium. The user may then input 12 the stored identifying indicia into the software.

As described above, after the user inputs 12 the identifying indicia, the user may optionally input 12 additional data such as text 76 describing the person.

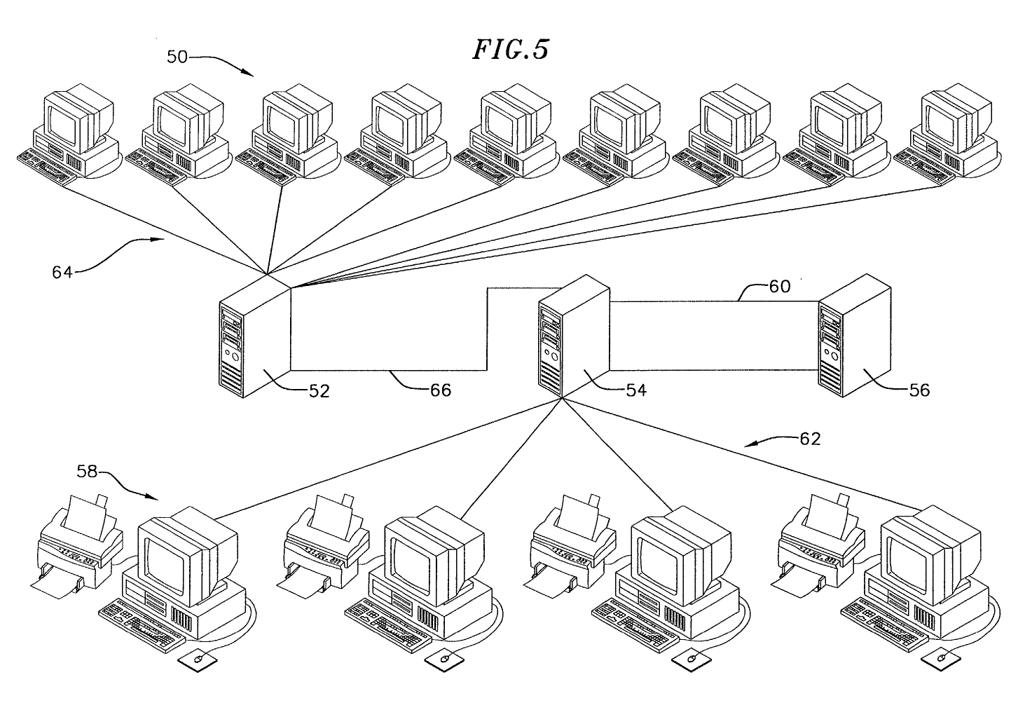

Referring again to FIGS. 1 and 3, once the information has been collected and entered into the user's computer 50, the computer transmits 14 the input information to a central storage server 56 as directed by the software or the user. For example, the user may establish a dial-up connection with the user's Internet service provider 52 and transfer the information to the central storage server 56 over the Internet as shown in FIG. 5. In an embodiment where software is used, the software could optionally include a file transfer client through which the user's computer 50 establishes a direct connection with the central storage server 56 via a direct modem connection or an Internet connection 64 through the user's Internet service provider 52. If an Internet service provider 52 is used, the Internet service provider 52 transmits the information through a T1 line 66 to the central storage server 56.

In an alternate embodiment, the user or the software itself can generate a file containing the input information. The file may then be sent 14 as an e-mail attachment to the central storage server 56.

Regardless of the method used to transmit 14 the information, the information may be updated periodically or on a real time basis. For example, the software may include a component that automatically updates the information by connecting the central storage server 56, either directly or via the user's Internet service provider 52, and sending updated files. In a further embodiment, the user's computer 50 may use information from the user's other software applications, to automatically generate updated information files and transmit those updated information files to the central storage server 56. The central storage server 56 could then access the database, find the corresponding data file, and overwrite the stored data with the updated data.

With reference to FIG. 5, for added security, the central storage server 56 could be insulated from unauthorized access and computer viruses by a secured server 54. In this embodiment, the user's computer 50 establishes a direct connection with the central storage server 56 via a direct modem connection or an Internet connection 64 through the user's Internet service provider 52. If an Internet service provider 52 is used, the Internet service provider 52 transmits the information through a T1 line 66 to the secured server 54 which, in turn, transmits the input information to the central storage server 56 through a network connection 60. The secured server 54 could use a variety of security devices such as a firewall, proxy server, or the like.

The central storage server 56 is optionally a server which stores 16 the emergency information for each building input and indexes 18 the information according to the name of the person. The central storage server 56 includes data storage media, such as magnetic storage, optical storage, EPROM, ROM, RAM, or the like storing the database. The central storage server 56 also includes a data communication device such as a modem, network interface, or the like. In an optional embodiment, the database is backed up on a computer readable medium such as a magnetic medium, optical medium, or the like.

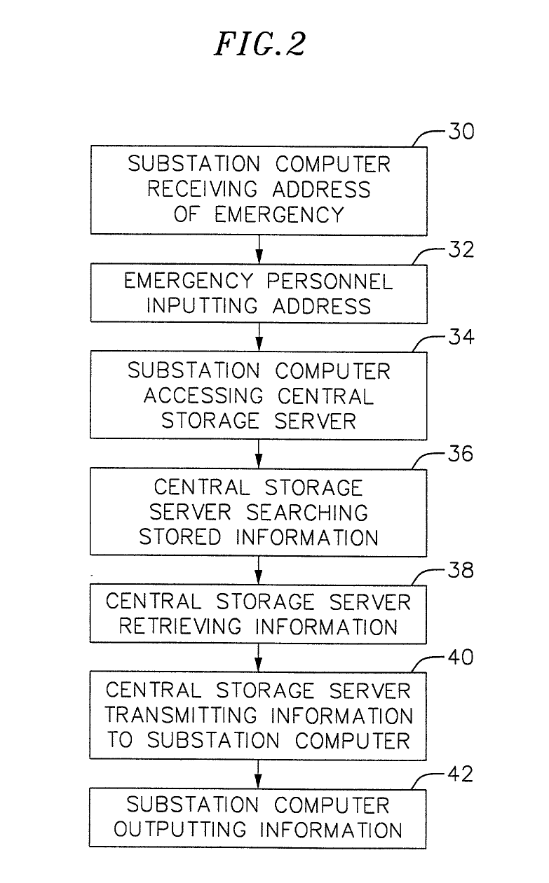

In one optional embodiment, as shown in FIGS. 1 and 2, the data may be stored centrally at the central storage server 56. The retrieval process for this embodiment is shown in FIG. 2. When an emergency occurs, the name of the person involved in the emergency is received 30 at a substation. Substation computers 58, such as a personal computer, could be located at police stations, fire stations, hospitals, and the like. In an alternate embodiment, substation computers 58 are located at a dispatcher's station. The dispatcher then provides the information to the appropriate emergency personnel. To retrieve the information, emergency personnel at a substation access 34 the emergency information on the central storage server 56 by inputting 32 the name into the substation computer 58. Each substation computer 58 includes software for accessing and downloading emergency information stored on the central storage server 56. While the substation computers 58 could access the emergency information using a direct modem connection or DSL connection, in an optional embodiment, a faster and more secure method is used. For example, each substation computer 58 may include an ISDN modem to dial directly to, and receive information directly from, the central storage server 56 through an ISDN line 62. The central storage server 56 searches 36 the database and retrieves 38 the database record storing the emergency information. The central storage server 56 retrieves 38 the information and transmits 40 the information back to the substation computer 58.

In an embodiment where a secured server 54 is used, shown in FIG. 5, the substation computers 58 communicate with the secured server 54 rather than the central storage server 56. The secured server 54 could use a variety of security measures to protect the information on the database from unauthorized access. When a substation computer 58 requests information, the secured server 54 communicates with the central storage server 56 through a network connection 60. The database record is transmitted to the secured server 54 which, in turn, transmits 22 the database record to the substation computer 58.

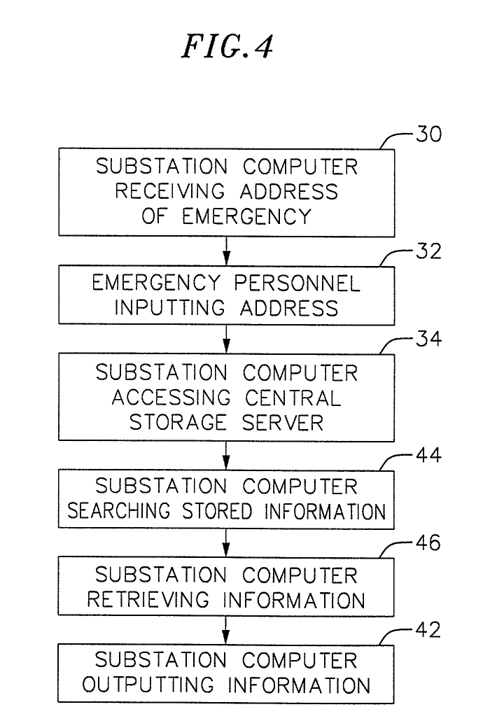

In an alternate embodiment, shown in FIGS. 3 and 4, the data may be stored locally at the substation computer 58. In this embodiment, the user additionally enters his or her residential address. As the central storage server 56 receives the information from the users, the central storage server 56 determines 20 the substation computer 58 nearest the user based on the user's street address. That is, the central storage server 56 sorts the data according to geographic location or area. The central storage server 56 periodically transmits a user's emergency information record to the substation computer 58 serving the geographic area in which the building is located. Thus, as shown in FIG. 4, the emergency information records are stored locally at on substation computers 58 so that when an emergency call is received 30, the records may be quickly searched 44 and retrieved 46 without resort to a communication line such as a telephone line, modem line, or the like.

In either embodiment, the information is output 42 after retrieval by the substation computer 58. In one embodiment, substation computers 58 are connected to a printer which allows emergency personnel to produce printed copies of the emergency information which can be taken to the emergency location for use.

While certain embodiments of the present invention have been shown and described it is to be understood that the present invention is subject to many modifications and changes without departing from the spirit and scope of the claims presented herein.

I claim:

1. A method for distributing information to emergency personnel of a selected geographic area comprising:
providing a central storage server having data storage media and data communication device;
storing data corresponding to at least an identifying indicia and name of each of a plurality of persons in a database in the data storage media at the central storage server;
indexing said data in the database according to the name of said person; and
upon receiving a request including a specified name from emergency personnel in the selected geographic area, said central storage server accessing said database, retrieving the data based on the received name, and transmitting the data retrieved to said requesting emergency personnel through said data communication device for output thereof.

2. The method of claim 1 wherein said identifying indicia comprises fingerprints of the person associated with said name.

3. The method of claim 1 wherein said identifying indicia comprises a photograph of the person associated with said name.

4. The method of claim 1 further comprising:
on a regular, periodic basis, receiving updated data for a person having a specified name;
accessing said database using said specified name; and
overwriting said data with said updated data.

5. A method for distributing information to emergency personnel, comprising:
providing a central storage server having data storage media and data communication device, the data storage media storing a database of street addresses, said street addresses divided into geographic areas;
providing a substation terminal serving one or more geogaphic areas, said substation terminal in communication with said central storage server via said data communication device;
transmitting data records corresponding to at least an identifying indicia, name, and street address of each of a plurality of persons to the central storage server;
the central storage server sorting said data records according to street address;
the central storage server transmitting data records corresponding to street addresses in a geographic area to a substation terminal serving said geographic area; and
upon receiving a request including a specified street address from emergency personnel in the selected geographic area, said substation terminal accessing said database, and retrieving the data record based on the received street address for output thereof.

6. The method of claim 5 wherein said data record includes fingerprints of the person associated with said street address.

7. The method of claim 5 wherein said data record includes a photograph of the person associated with said street address.

8. The method of claim 5 further comprising:
on a regular, periodic basis, receiving updated data record for a person having a specified street address; and
transmitting said updated data record to a substation terminal serving the geographic area bounding the specified street address.

9. A method for distributing information to emergency personnel of a selected geographic area comprising:
providing a central storage server having data storage media and data communication device;
a user transmitting data corresponding to at least a photograph and a name of a person to said central storage server;
storing said data in a database in the data storage media at the central storage server;
indexing said data in the database according to the name of said person; and
upon receiving a request including a specified name of a person from emergency personnel in the selected geographic area, said central storage server accessing said database, retrieving the data based on the received name, and transmitting the data retrieved to said requesting emergency personnel through said data communication device for output thereof.

10. The method of claim 9 wherein said data further includes fingerprints of the person associated with said name.

11. The method of claim 9 wherein said data further includes a description of the person associated with said name.

12. The method of claim 9 further comprising:
on a regular, periodic basis, receiving updated data for a person having a specified name;
accessing said database using said specified name; and
overwriting said data with said updated data.
